(19) United States
(12) Patent Application Publication
(10) Pub. No.: US 2008/0120131 A1
(43) Pub. Date: May 22, 2008

(54) Personalized note card and shoe delivery for same

(76) Inventor: Gary B. Rogers, Cincinnati, OH (US)

Correspondence Address: Gary B. Rogers, 4311 34th Avenue, Cincinnati, OH, 45209, US

(21) Appl. No.: 11/975,774

(22) Filed: Oct. 22, 2007

Related U.S. Application Data
(60) Provisional application No. 60/860,442, filed on Nov. 21, 2006.

(51) Int. Cl. G06Q 99/00

(52) U.S. Cl. 705/1; 206/232

(57) ABSTRACT

Personalized note card and shoe delivery for same is disclosed. The personalized note card system contains the required elements to allow a first person to customize a personal, yet inspirational hand written note card system and, more particularly, to a note card and card placing system and method. Additionally, the customized note cards are to be placed in the recipients shoe on the day of a game, event or any other special day.

### RELATED APPLICATIONS

The present application claims the filing benefit of U.S. Provisional Application Ser. No. 60/860,442, filed Nov. 21, 2006, the disclosure of which is incorporated herein by reference in its entirety.

### FIELD OF THE INVENTION

The present invention relates generally to a personal, yet motivational hand written note card system and, more particularly, to a note card and card placing system and method.

### BACKGROUND OF THE INVENTION

Sending note cards to friends and family is a tradition that goes back for many years, which allow a first person to put a thought or feeling in writing to give to a second person. Typically, a person who desires to give a note card to someone will purchase it from a store or create an e-card which contains a preprinted message and the sender will sign their name. It is common practice to purchase the card, sign the card and address the envelope for mailing or simply handing the card to the recipient. Popular occasions for sending a note card include holidays, get well, birthdays, weddings and sympathy. Many note cards exist on the market today but a disadvantage to the note cards which are currently on the market is that it is difficult to find a card that has a personal and motivational message to fit a particular event as well as to follow a desired time period such as an entire soccer season. Another disadvantage to the note cards on the market today is that the recipient will only benefit from the note card for that day only. A further disadvantage is that the delivery method from the first person to the second person (hereinafter referred to as “recipient”) closes the door for repetitive reinforcement for a period of time and by placing the note card in the recipients shoe you provide an element of surprise and thoughtfulness on behalf of the recipient.

Prior patents disclosing note cards include:

| Inventor | U.S. Pat. No. | Year of Issue |
|---|---|---|
| Wolf | 5,219,184 | 1993 |
| Kearns et al. | 5,626,551 | 1997 |
| Laurash et al. | 6,802,538 | 2004 |
| Simpson | 6,453,300 | 2002 |
| Laurash et al. | 6,682,099 | 2004 |
| Stefany | 6,698,117 | 2004 |

While these patents fulfill their respective, particular objective and requirements, the aforementioned patents, none of these contain a personalized note card system with a motivational or inspirational handwritten message which is placed in the shoe for a duration of time (i.e. an entire soccer season).

Wolf, U.S. Pat. No. 5,219,184 discloses a gift card for accompanying a gift expressing awareness of an occasion and providing a return note expressing gratitude. The gift card has a fold which defines a first portion provided with language expressing awareness of the occasion, and a second portion having language expressing gratitude for the gift and gift card.

Kearns et al., U.S. Pat. No. 5,626,551 discloses a kit containing the required elements to enable one to manufacture his or her own greeting cards, note cards, and/or envelopes. The invention also relates to a method of manufacturing a greeting card, note card, or an envelope from ordinary paper stock or from paper stock containing decorative scenes thereon.

Simpson, U.S. Pat. No. 6,453,300 discloses a method an system for enabling a first person to produce a customized note card for a second person, including: providing a computer-readable storage medium having a control program and non-customized information stored thereon; obtaining data from the first person which relates to the second person; using the data to generate a customization code; providing the gift and the customization code to the second person; causing the control program to request the customization code from the second person; and using the customization code to select information from the non-customized information to provide a customized display to the second person.

Laurash et al., U.S. Pat. No. 6,682,099 discloses gift card forms and methods of making and using gift card forms. The gift card form permits uniquely messaging each gift card. An appropriate gift card form can be printed at a time after manufacturing to allow a vendor to personalize the gift card.

Stafany, U.S. Pat. No. 6,698,117 discloses a greeting card including an ornament/charm, and a jewelry fashion accessory either packaged together or purchased separately from a single merchandising fixture is provided. This card system allows the sender to provide a convenient object for the recipient to display on a fashion accessory, thus providing for the long term remembrance of the sender and also stimulate sales of greeting cards so that ornaments/charms can be collected to adhere to the fashion accessory received with the first card.

Laurash et al., U.S. Pat. No. 6,802,538 (Continuation of application Ser. No. 09/841,675/U.S. Pat. No. 6,682,099) discloses gift card forms and methods of making and using gift card forms. The gift card form permits uniquely messaging each gift card. An appropriate gift card form can be printed at a time after manufacturing to allow a vendor to personalize the gift card.

While these devices fulfill their respective, particular objectives and requirements, the aforementioned patents do not describe a personalized note card system that allows a first person to motivate and be inspiring through a handwritten message in which the note card is placed in the recipients shoe. In this respect, the personalized note card system according to the present invention substantially departs from the conventional concepts and designs of the prior art, and in doing so provides a personal and motivational hand written message to be given to a someone for the purpose of living up to ones greatest potential. It can be appreciated that the need for a personalized note card system and a method of delivery exists. These note cards can be used for motivation, building self-esteem and connecting with others over a period of time. Therefore, it can be appreciated that there exists a continuing need for a personalized note card of this type to allow a first person to connect with someone (i.e. parent/child, coach/child) for inspirational purposes over a period of time. In this regard, the present invention substantially fulfills this need.

### SUMMARY OF THE INVENTION

Before an explanation of at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

An example of the present invention is a package of 12-15 note cards which are approximately 3″×5″ comprised of one ply card stock. These note cards contain sports related indicia on the card with each one having a unique message. The front panel of the card is bearing printed indicia and contains a preprinted message which is inspirational, motivating and encouraging in nature. The back panel is blank so a personal message may be hand written by a first person and directed to an event or occasion to be given to the recipient.

The present invention is therefore directed to a personalized note card system to allow a first person to deliver a personal, yet inspirational hand written message on a note card tailored to a specific event and place the note card in the recipients shoe for a duration of time.

The invention also provides a method to motivate children or adults for the purpose of being successful and confident, the present invention endeavors to make children and adults experience a high self image by reinforcing good choices they make and thus have a positive outlook on life and continue to make good choices. These note cards will appeal to people of all age levels and may focus on any particular area in life which people are involved in but also incorporates other areas in life like education, attitude, peer pressure, friends/family, work and overall areas that children and adults deal with in life.

The note cards are to be placed in the recipients shoe on the day of a game, event or any other special day. Before putting on a shoe a recipient will take out the note card and read the message. Through these note cards may be used sporadically, the purpose of a set of 12-15 note cards, for example, can be for reinforcing good choices over a period of time such as a sports season, part of a school year, period of work or any other segment of time.

Accordingly, an advantage of the invention is to provide children and adults with consistent reminders of encouragement (via placing the note card in the recipients shoe for a duration of time) to help them reach their greatest potential not just in a certain area such as athletics or work but to also help children and adults in the game of life.

A further advantage of the present invention is to provide a new way of giving note cards which is susceptible of a low labor cost of manufacture with regard to both materials and labor, and then susceptible of low prices of sale to the consuming public, thereby producing and giving these handwritten messages which are motivational and inspirational will be economically available to the buying public.

Personalized note cards may contain messages that pertain to different themes in life like sports, school or work but they also may contain quotes, messages or any other words from professional or well respected children and adults in each of those areas. An example might be in such as a sports theme note card, you may have a group of professional female and male athletes with their unique message on the one side as it pertains to the concept of CHECK YOUR GAME and the overall improvement in life.

CHECK YOUR GAME is a trademark of Gary B. Rogers and stands for the concept of encouraging people to make good choices in the game of life.

Personalized note cards may also be given to oneself by oneself. An example may be that a person writes down 12 messages to themselves that deal with the different areas of their lives like work, family, sports, extracurricular activities, church, etc. Then the time comes when they need a pick me up, they then can slip that specific note card in their shoe for the next day and be motivated by their own words when they were dealing with that specific area a little better than they are dealing with at that current time.

Personalized note cards may also work with other brands, companies, churches or schools as a way to communicate to children and adults that their specific organization endorses positive reinforcement and encouragement which these personalized note cards accomplishes. These note cards would have a graphic somewhere on the card that has that organizations logo or name somewhere on it.

Personalized note cards are unique because of their shape, design, the concept behind them with CHECK YOUR GAME but also because of where you place these notes . . . in the shoe where the foot goes.

To motivate children and adults for the purpose of being successful and confident, the present invention endeavors to make children and adults experience a high self-image by reinforcing good choices they make and thus have a positive outlook on life and continue to make good choices.

A primary objective of the present invention is to provide a motivational and inspirational handwritten note card and a method of producing same.

A more particular objective of the present invention is to provide a personal yet inspirational handwritten message or thought which can be easily and efficiently customizable by the first person and given to the recipient to make a connection.

Accordingly, in described embodiments of this invention, a personalized note card system is used for motivational purposes, and more particularly to inspire, connect and encourage both children and adults in life. A result for the note card system can be to build self-esteem and confidence and which allows both children and adults to live up to their greatest potential.

The advantages of the present invention will be more fully appreciated by reference to the appended drawings and detailed description.

### BRIEF DESCRIPTION OF THE DRAWINGS

The drawings are not necessary to scale, emphasis instead being placed upon illustrating the principles of the invention.

FIG. 1 depicts one embodiment of the foot-note suitable for giving with the present invention.

FIG. 2 depicts one embodiment of the note card along the arrows 7-7.

FIG. 3 schematically illustrates a preferred embodiment of the personalized note card that is used in accordance with the invention to create, customize and deliver the note cards of the present invention.

FIG. 4 is an exploded view of a note card embodying the principles of the present invention.

FIG. 5 depicts the boundary and message area to create and customize a personalized note card.

### DETAILED DESCRIPTION

While the preferred embodiments of the invention have been described as well as illustrated, it will be apparent to those of ordinary skill in the art that minimal changes and modifications may be made without deviating from the inventive concepts and true meaning of the invention as set forth above, it is intended by the appended claims to cover all changes and modifications which come within the spirit and scope of the present invention.

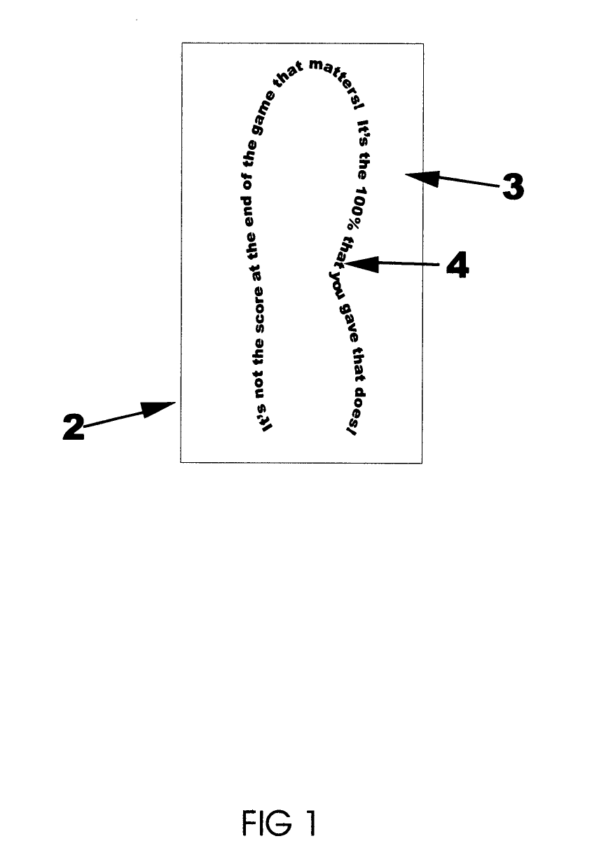

Referring first to FIG. 1, a note card front panel is shown at 2. Note card front panel 2 is preferably formed of any paper appropriate for use such as a medium weight opaque bond paper. The material forming the note card 2 will be chosen to coordinate in color and printed indicia with the appearance of the card 3. The dimensions of the note card front panel 2 may vary depending upon a number of factors, such as the occasion, the recipient, or the size of the note card front panel 2. The language 4 on the front of the note card 3 are of equivalent dimensions and propionate to the height of the card. Those skilled in the art will recognize that many different shapes of indicia are ultimately obtainable by the number of occasions or events ultimately possible.

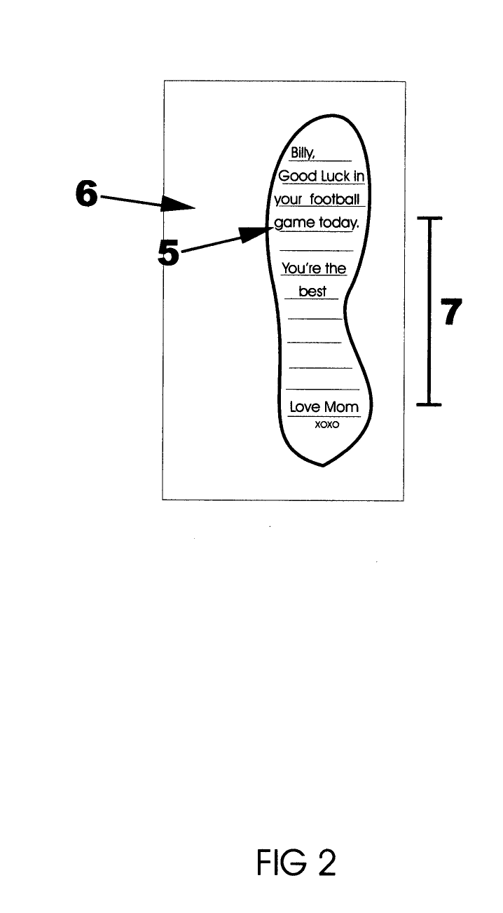

Referring to FIG. 2, a note card back panel is shown at 6. The personalized hand written message 5 will be hand written and fit a specific event or occasion.

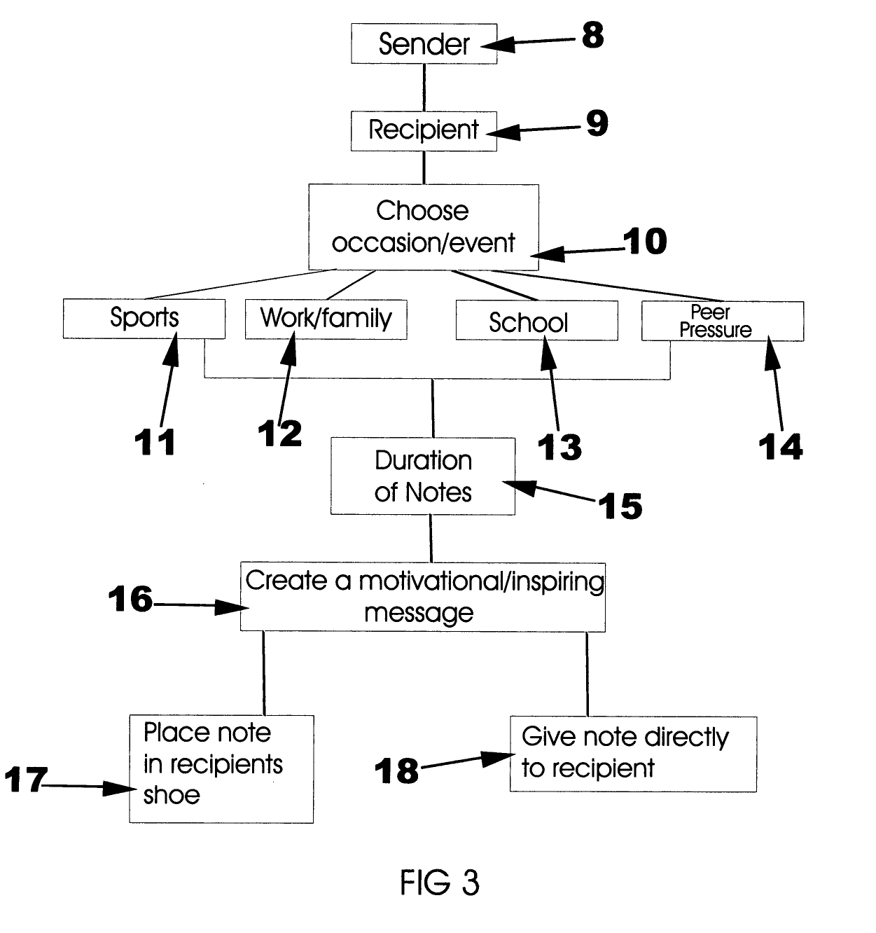

FIG. 3 is a flow chart showing the method of producing personalized note cards. Sender 8 will select recipient 9 and choose occasion or event. Sender 8 will consider sports 11, work/family 12, school 13 or peer pressure 14. Sender 8 will consider the duration of time 15 and create a motivational and inspiring message 16. Sender 8 will place note card in recipients shoe 17 or give note card directly to recipient 18.

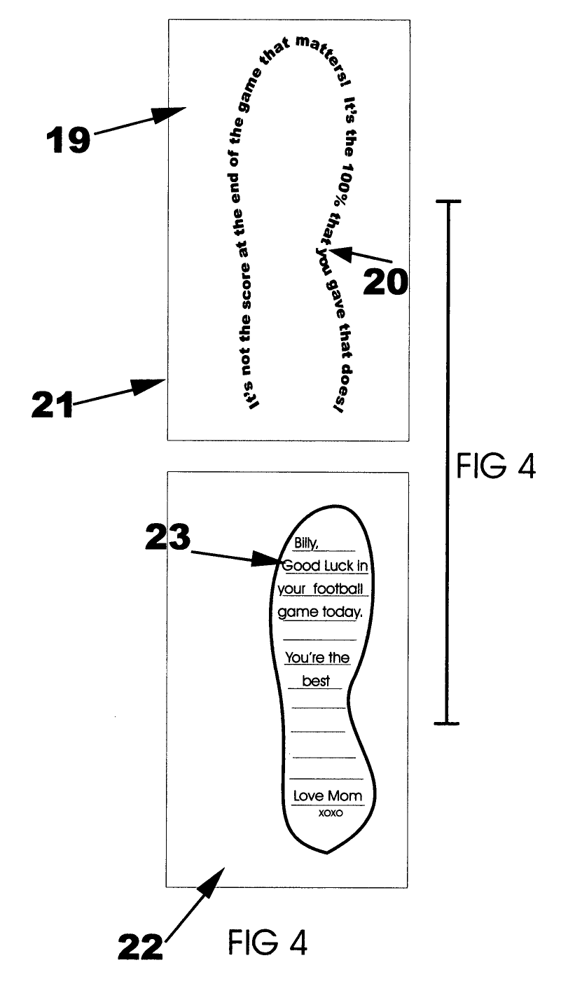

Referring to FIG. 4 which illustrates the combination of the use of the note card 21, 22 the language 20, 23, the front side 19 and the back side 22 of the note card system.

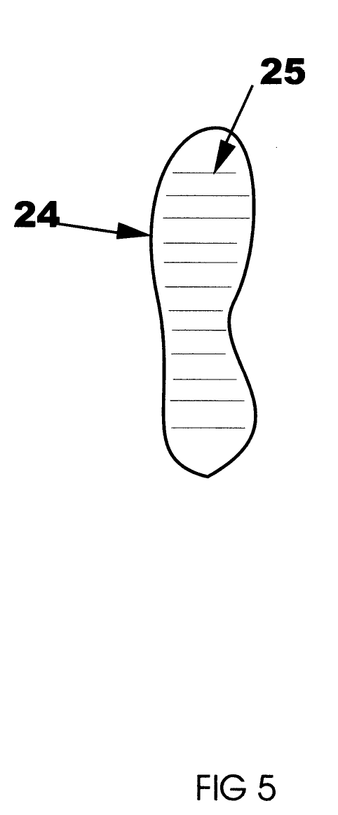

Reference is now made to FIG. 5, the boundary 24 and message area 25 where the sender 8 can create a motivational and inspiring message 16 to place note card in recipients shoe 17.

It should be recognized that various other embodiments, alternatives, and modifications aside from those expressly stated, are possible within the scope and spirit of the claims.

What is claimed is:

1. A package of note cards comprising:
a plurality of note cards each having shoe-shaped boundary and a message area enclosed and surrounded by the shoe-shaped boundary;
each card having a size and a shape to fit into a person's shoe; and
each card having indicia preprinted thereon forming an inspirational or motivational message relating to a time-sensitive event.

2. The package of claim 1 wherein:
each card is generally rectangular in shape; and
the shoe-shaped boundary of each card includes a shoe-shaped border area printed thereon.

3. The package of claim 1 wherein:
the shoe-shaped boundary of each card includes a shoe-shaped border area formed of the indicia.

4. The package of claim 1 wherein:
each card has a surrounding edge cut in the shape of a shoe to form the shoe-shaped boundary thereof.

5. The package of claim 1 wherein:
at least two different cards of the plurality have indicia preprinted thereon forming respectively different inspirational or motivational messages relating to different time-sensitive events.

6. The package of claim 1 wherein:
at least two different cards of the plurality have indicia preprinted thereon forming respectively different inspirational or motivational messages.

7. The package of claim 1 wherein:
the message area of each card includes a surface area adapted for handwriting a message thereon.

8. The package of claim 1 wherein:
each card includes on a side thereof opposite that on which the indicia is preprinted having a surface area thereon adapted for handwriting a message thereon.

9. The package of claim 1 wherein:
each card is formed of one ply of card stock having the preprinted indicia on one side thereof and a second side that is blank.

10. The package of claim 1 wherein:
each card is formed of one ply of card stock having a surface that is printable with a non-impact laser or ink-jet printer.

11. A method comprising the steps of providing the package of claim 1 and further comprising:
delivering the card to a person by placing the card in a shoe of the person.

12. A method of delivering motivational or inspirational messages comprising:
providing a package containing a plurality of note cards, each card having shoe-shaped boundary, at least one message area, and a size and a shape to fit into a person's shoe;
providing, on a message area on the card, an inspirational or motivational message relating to a time-sensitive specific event; and
delivering the card to a person by placing the card in a shoe of the person.

13. The package of claim 12 wherein:
the providing of the package includes providing the plurality of note cards each having a message area enclosed and surrounded by the shoe-shaped boundary having indicia preprinted thereon forming the inspirational or motivational message.

14. The package of claim 12 wherein:
the providing of the package includes providing the plurality of note cards each having the shoe-shaped boundary formed of either:
a shoe-shaped border design printed on the card;
a shoe-shaped border area formed of preprinted indicia; or
a surrounding edge cut in the shape of a shoe.

15. The package of claim 12 wherein:
the providing of the package includes providing at least two different cards having indicia preprinted thereon forming respectively different inspirational or motivational messages relating to different time-sensitive events.

16. The package of claim 12 wherein:
the providing of the package includes providing at least two different cards having indicia preprinted thereon forming respectively different inspirational or motivational messages.

17. The package of claim 12 wherein:
the providing of the inspirational or motivational message includes providing the cards each having messages preprinted thereon relating a time-sensitive event.

18. The package of claim 12 wherein:
the providing of the inspirational or motivational message includes writing by hand on one of the cards provided in the package a personal message to the person relating to a time-sensitive specific event.

19. The package of claim 12 further comprising:
providing each of the cards each with a preprinted message on one side thereof; and
writing by hand, on one of the cards on a side thereof opposite the side having the preprinted message, a personal message to the person.

20. The package of claim 12 further comprising:
providing each of the cards each with a preprinted message thereon; and
writing by hand in a message area a personal message to the person.
